(19) United States
(12) Patent Application Publication
(10) Pub. No.: US 2025/0221575 A1
(43) Pub. Date: Jul. 10, 2025

(54) TAP CONTROL IN A STAND MIXER APPLIANCE

(71) Applicant: Haier US Appliance Solutions, Inc., Wilmington, DE (US)

(72) Inventors: Tomas Garces, Louisville, KY (US); Andrew Combs, Louisville, KY (US)

(21) Appl. No.: 18/409,189

(22) Filed: Jan. 10, 2024

(51) Int. Cl. A47J 43/08; A47J 43/044

(52) U.S. Cl. CPC A47J 43/082; A47J 43/044; A47J 2043/04454

(57) ABSTRACT

A stand mixer includes a housing, a motor disposed in the housing, a mixing shaft operably coupled to the motor, a controller, and an accelerometer in data communication with the controller. The controller is configured to receive tap data from the accelerometer, determine a command based upon the tap data from the accelerometer, and operate the stand mixer in response to the determined command.

### FIELD OF THE INVENTION

The present subject matter relates generally to operating stand mixers.

### BACKGROUND OF THE INVENTION

Stand mixers are generally used for performing mixing, churning, or kneading involved in food preparation. Typically, stand mixers include a motor configured to provide torque to one or more driveshafts. Users may connect various utensils to the one or more driveshafts, including whisks, spatulas, or the like. Operating a stand mixer is frequently a manual process, which involves the user actively monitoring the mixing process. Thus, during the mixing process, a user is positioned close to the mixer in order to monitor the content doneness and to turn off the stand mixer when the desired doneness is reached. However, users frequently attend to multiple activities when baking or cooking, and often have dirty/messy hands. It is undesirable for a user to operate the stand mixer with dirty/messy hands, causing the user to clean up in between baking or cooking steps.

Accordingly, a stand mixer configured such that a user may operate the stand mixer with dirty/messy hands would be advantageous.

### BRIEF DESCRIPTION OF THE INVENTION

Aspects and advantages of the invention will be set forth in part in the following description, or may be apparent from the description, or may be learned through practice of the invention.

In one example embodiment, a stand mixer is provided. The stand mixer includes a housing with a motor disposed in the housing. A mixing shaft is operably coupled to the motor. The stand mixer also includes a controller and an accelerometer in data communication with the controller. The controller is configured to receive tap data from the accelerometer, determine a command based upon the tap data from the accelerometer, and operate the stand mixer in response to the determined command.

In another example embodiment is a method for operating a stand mixer. The stand mixer includes a housing, a motor disposed in the housing, a mixing shaft operably coupled to the motor, a controller, and an accelerometer in data communication with the controller. The method includes receiving, by the controller, tap data from the accelerometer, determining, by the controller, a command based upon the tap data from the accelerometer, and operating, by the controller, the stand mixer in response to the determined command.

In another example embodiment is a method for operating a stand mixer. The stand mixer includes a housing, a motor disposed in the housing, a controller, and a sensor in data communication with the controller. The method includes receiving, by the controller, tap data from the sensor, determining, by the controller, a command based upon the tap data from the sensor, and operating, by the controller, the stand mixer in response to the determined command.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side view of an example stand mixer with a bowl according to example embodiments of the present disclosure.

FIG. 2 provides a side view of the stand mixer with a mixing attachment according to example embodiments of the present disclosure.

FIG. 3 illustrates a flow diagram of an example method of operating a stand mixer according to aspects of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related.

The terms “coupled,” “fixed,” “attached to,” and the like refer to both direct coupling, fixing, or attaching, as well as indirect coupling, fixing, or attaching through one or more intermediate components or features, unless otherwise specified herein.

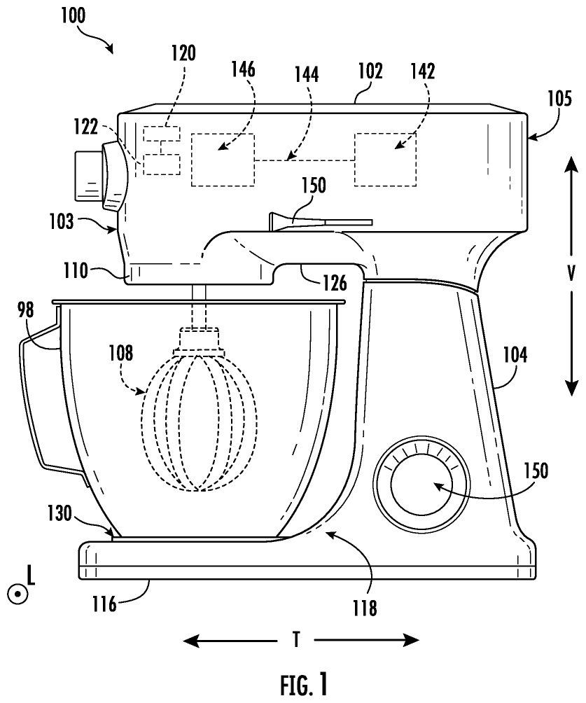

The present disclosure provides a mixer appliance with a secure mixing attachment coupling to a mixing shaft of the mixer appliance. This secure coupling may allow the mixer to rotate the shaft with the secured mixing attachment in clockwise and counterclockwise motions. The figures depict an example stand mixer appliance 100 that may be configured in accordance with various aspects of the present disclosure. It should be appreciated that the invention is not limited to any particular style, size, model, or shape for stand mixer appliance 100. The example embodiment in FIG. 1 is for illustrative purposes only. For example, appliance 100 may have different shapes and appearance for one or more parts, different motor and gear configurations, and other differences while remaining within the scope of the claimed subject matter.

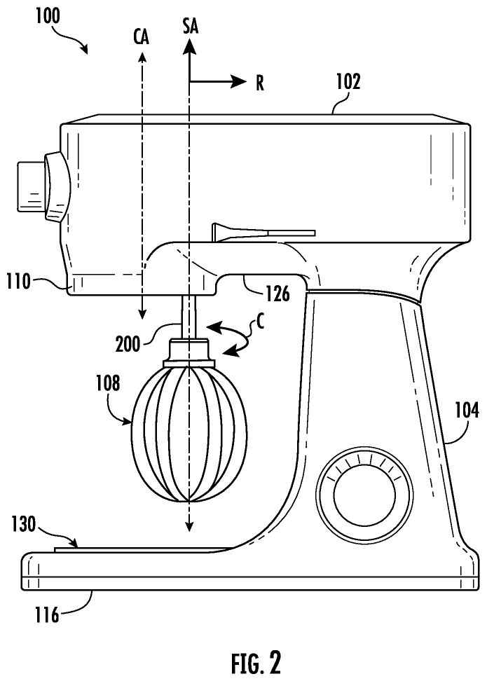

With reference for FIGS. 1 and 2, for the particular embodiment shown, a stand mixer appliance 100 includes a housing 102 and a base 104. Stand mixer 100 may extend between housing 102 and base 104 in a vertical direction V, across housing 102 in a lateral direction L, and from a front 103 to a back 105 in a transverse direction T. The vertical direction V, lateral direction L, and transverse direction T are perpendicular to one another.

Housing 102 may be pivotally mounted to base 104 and extends transversely between front 103 and back 105 of stand mixer appliance 100 when in the mixing position shown in FIG. 1. In some embodiments, housing 102 may be non-pivotably attached to base 104. Other configurations may be used where housing 102 may allow for access to a bowl 98 or to a removable mixing attachment 108, as otherwise understood. For this embodiment, base 104 includes upright support 112 and a horizontal base member 116. As shown, upright support 112 extends vertically from horizontal base member 116 and horizontal base member 116 extends transversely in front of upright support 112. Horizontal base member 116 may include a scale 130. In some embodiments, scale 130 may be concave, grooved, or otherwise shaped to accept bowl 98. Scale 130 may be generally configured to weigh bowl 98 and the contents therein.

Housing 102 includes an attachment support 110. A motor 142 is disposed within the housing 102. Attachment support 110 is located on a lower portion or underside 126 of housing 102 and forward of upright support 112 along transverse direction T. A mixing shaft 200 extends from attachment support 110. Removable mixing attachment 108 removably attaches to shaft 200.

Drivetrain 144 connects motor 142 with one or more gears 146 for causing rotation of attachment 108 or mixing shaft 200, e.g., mixing shaft 200 may be operably coupled to motor 142. Gears 146 may allow for selection by the user of different rotating speeds for attachment 108. In general, mixing attachment 108 may be coupled to shaft 200 prior to rotation of shaft 200 by motor 142.

Stand mixer 100 may include one or more controls 150 for operations such as selectively powering motor 142, choosing the speed of rotation for attachments 108, locking position of housing 102 relative to base 104 during mixing, or other features. In some embodiments, controls 150 may include a rotational direction operation selection, allowing a user to select the direction of rotation of the mixing shaft 200.

In certain embodiments, attachment support 110 may accept more than one attachment 108. Various types of attachments 108 may be used including e.g., whisks, paddles, dough hooks, beaters, and others for purposes of mixing articles or mechanically manipulating articles within bowl 98 or other containers supported by base 104. During use, attachment support 110 with mixing shaft 200 may rotate attachment 108 in a circular or planetary fashion. Spinning in a planetary fashion, as used herein, includes spinning an object (e.g., shaft 200) about a first axis and revolving the object around a second axis, the object offset from the second axis. For example, shaft 200 may spin about a shaft axis SA, and revolve around a central axis CA, shaft 200 offset from central axis CA to generate spinning in a planetary rotation. Shaft axis SA may also be offset from central axis CA. In some embodiments, motor 142 may be disposed within base 104, including within upright support 112.

As shown in FIG. 2, mixing shaft 200 may rotate within attachment support 110.

Mixing attachment 108 and mixing shaft 200 are rotatable by motor 142 in planetary rotation. Mixing shaft may define the shaft axis SA, with a radial direction R extending therefrom perpendicular to the shaft axis SA, and a circumferential direction C extending around the central axis CA. Mixing shaft 200 may rotate around central axis CA, wherein mixing shaft 200 is rotating in circumferential direction C. Additionally or alternatively, motor 142 may be operable to selectively rotate mixing attachment 108 in a clockwise direction or a counterclockwise direction in circumferential direction C around shaft axis SA. Thus, mixing shaft 200 may be reversible, or moveable in either direction during use. Attachment of mixing attachment 108 to shaft 200 allows for motion in both directions, clockwise and counterclockwise, by motor 142. In other words, motor 142 can rotate mixing attachment 108 and/or shaft 200 in a clockwise direction and can switch and rotate mixing attachment 108 and/or shaft 200 in a counterclockwise direction. Such movement may be directed by a user (e.g., by use of controls 150) or may be directed independent of a user, e.g., by using a timer, by using a controller, described hereinbelow, in operable communication with motor 142, or as otherwise understood.

In general, stand mixer 100 may include a controller 120. In particular, controller 120 may be located within housing 102. For instance, controller 120 may be a microcontroller, as would be understood, including one or more processing devices, memory devices, or controllers. Controller 120 may include a plurality of electrical components configured to permit operation of stand mixer 100 and various components therein (e.g., motor 142). For instance, controller 120 may include a printed circuit board (PCB) with various components coupled thereto, as would be understood by those of ordinary skill in the art.

As used herein, the terms “control board,” “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of stand mixer 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120. According to still other example embodiments, controls 150 may include one or more microprocessors and/or one or more memory devices. Accordingly, certain components of stand mixer 100 may be controlled directly from controls 150. For example, controller 120 may be generally configured to perform a mixing cycle, whereby stand mixer 100 may be operated to mix food contents, such as food contents in bowl 98.

The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases and/or may be split up so that the data is stored in multiple locations. In addition, or alternatively, the one or more database(s) can be connected to a remote user interface (not shown) through any suitable network(s), such as through a high bandwidth local area network (LAN) or wide area network (WAN). In this regard, for example, controller 120 may further include a communication module or interface that may be used to communicate with one or more other component(s) of stand mixer 100, controller 120, an external appliance controller, an external device, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

In general, stand mixer 100 may include a sensor 122, such as an accelerometer 122, in data communication with controller 120. In general, controller 120 may be configured to receive tap data from accelerometer 122, determine a command based upon the tap data from accelerometer 122, and operate stand mixer 100 in response to the determined command. Further, controller 120 may be generally configured to determine a number of taps (bumps, hits, physical interactions) at housing 102 from the tap data from accelerometer 122. In particular, the tap data from accelerometer 122 may include determined changes in vibrations of housing 102. For example, a number of changes in vibrations of housing 102 detected by accelerometer 122 may correspond to a number of taps at housing 102. Moreover, accelerometer 122 may be configured to determine changes in vibrations of housing 102 by comparing a measured vibration at housing 102 to a threshold vibration value, e.g., determining the changes in vibration may include determining the measured vibration at housing 102 surpasses the threshold vibration value.

In general, when controller 120 determines a command based upon the tap data from accelerometer 122, the command may be determined based upon the total number of taps determined from the tap data from accelerometer 122. In other words, the total number of taps generally corresponds to a respective command. The commands that stand mixer 100 may be configured to operate may be starting a timer, pausing the timer, initiating scale 130, zeroing scale 130, pausing motor 142, reducing a speed of motor 142, and reversing the direction of motor 142. In one example scenario, the total number of taps interpreted by controller 120 may be one (1) tap, resulting in the starting of the timer, e.g., starting a thirty second timer. In this same scenario, two (2) taps may result in pausing the timer, and three (3) taps may result in reversing the direction of motor 142. In other example scenarios, the total number of taps may cause a series of commands, such as one (1) tap at housing 102 resulting in pausing the timer and pausing motor 142.

Moreover, controller 120 may be further configured for data communication with an external device (not shown), such as a smartphone, laptop, tablet, or any suitable device configured to wirelessly interface with stand mixer 100, e.g., through high bandwidth local area network (LAN) or wide area network (WAN). In the present example embodiment, controller 120 may be configured to receive command data from the external device. For example, the command data may be indicative of which of the respective commands corresponds to a respective total number of taps. In other words, the command per respective total number of taps may be customizable through the external device, e.g., a user may set the command for receiving one (1) tap to any suitable command, and two (2) taps to any other suitable command, etc. As one skilled in the art will appreciate, the customization of the command is not limited to specific taps and may include systems such as trackpad or mouse controls, where gestures or clicks may also correlate to different commands. Such trackpad and related systems utilizing gestures and clicks would be understood by those skilled in the art, and will not be described in further detail for the sake of brevity.

In some additional or alternative embodiments, sensor 122 may be a capacitive touch sensor. In general, the capacitive touch sensor may detect changes in capacitance at housing 102, such that a number of changes in capacitance at the housing corresponds to a number of taps at housing 102. Accordingly operation of stand mixer 100 with the capacitive touch sensor is similar to operation as described above, where controller 120 may determine a command based upon the tap data from the capacitive touch sensor, and the command may be determined based upon the total number of taps determined from the tap data from the capacitive touch sensor.

As one skilled in the art will appreciate, the above described embodiments are used only for the purpose of explanation. Modifications and variations may be applied, other configurations may be used, and the resulting configurations may remain within the scope of the invention. For example, stand mixer 100 is provided by way of example only and aspects of the present subject matter may be incorporated into any other suitable stand mixer appliance.

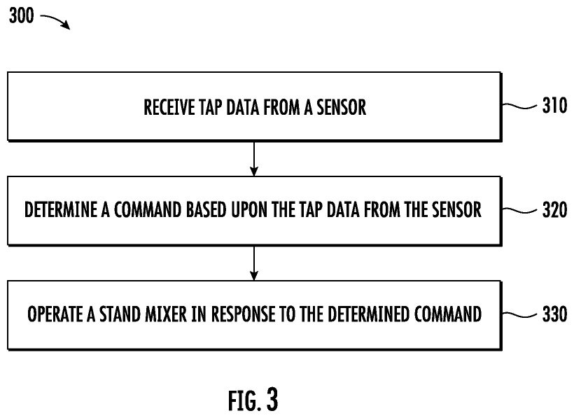

Referring now to FIG. 3, a flow diagram of one embodiment of a method 300 of operating stand mixer 100 is illustrated in accordance with aspects of the present subject matter. In general, method 300 will be described herein with reference to the embodiments of stand mixer 100 and related elements described above with reference to FIGS. 1 and 2. However, it should be appreciated by those of ordinary skill in the art that the disclosed method 300 may generally be utilized in association with apparatuses and systems having any other suitable configuration. In addition, although FIG. 3 depicts steps performed in a particular order for purposes of illustration and discussion, the method discussed herein is not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 3, at (310), method 300 may generally include controller 120 receiving tap data from accelerometer 122. In other words, controller 120 may receive tap data from accelerometer 122 and determine the number of taps at housing 102 from the tap data. In particular, the tap data from accelerometer 122 may include determined changes in vibrations of housing 102, where the number of changes in vibrations of housing 102 detected by accelerometer 122 may correspond to the number of taps at housing 102. Moreover, accelerometer 122 may determine changes in vibrations of housing 102 by comparing a measured vibration at housing 102 to a threshold vibration value, e.g., determining the changes in vibration may include determining the measured vibration at housing 102 surpasses the threshold vibration value.

At (320), method 300 may generally include determining a command based upon the tap data from accelerometer 122. For example, the command may be determined based upon the tap data from accelerometer 122. As described above, the total number of taps may generally correspond to a respective command, where the commands that stand mixer 100 may be configured to operate may be starting a timer, pausing the timer, initiating scale 130, zeroing scale 130, pausing motor 142, reducing a speed of motor 142, and reversing the direction of motor 142.

At (330), method 300 may generally include operating stand mixer 100 in response to the determined command. In other words, the stand mixer 100 may be operated according to the total number of taps at housing 102, such as the stand mixer 100 may execute the determined command. Moreover, method 300 may include receiving command data from the external device. For example, the command data may indicate which of the respective commands corresponds to a respective total number of taps. As described above, the command per respective total number of taps may be customizable through the external device, e.g., a user may set the command for receiving one (1) tap to any suitable command, and two (2) taps to any other suitable command, etc.

As may be seen from the above, the stand mixer may be tapped to be operated. A user may be able to tap the stand mixer with knuckles, wrist, or forearm to perform multiple operations. A sensor, such as an accelerometer, may pick up minute vibrations which can be converted to different actions/operations. Other sensors can be used such as capacitive sensors. Additionally, the user may customize the desired functions of the stand mixer through an external device.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A stand mixer, comprising:
a housing;
a motor disposed in the housing;
a mixing shaft operably coupled to the motor;
a controller; and
an accelerometer in data communication with the controller, the controller configured to:
receive tap data from the accelerometer;
determine a command based upon the tap data from the accelerometer; and
operate the stand mixer in response to the determined command.

2. The stand mixer of claim 1, wherein the controller is further configured to determine a total number of taps from the tap data from the accelerometer.

3. The stand mixer of claim 2, wherein the command is determined based upon the total number of taps determined from the tap data from the accelerometer, the total number of taps corresponds to a respective command.

4. The stand mixer of claim 3, wherein operating the stand mixer in response to the command comprises one of starting a timer, pausing the timer, initiating a scale, zeroing the scale, pausing the motor, reducing a speed of the motor, and reversing a direction of the motor.

5. The stand mixer of claim 4, wherein the controller is further configured for data communication with an external device, the controller configured to receive command data from the external device, the command data indicative of which of the respective commands corresponds to a respective total number of taps.

6. The stand mixer of claim 2, wherein the accelerometer is configured to determine changes in vibrations of the housing, and wherein the tap data from the accelerometer comprises a number of changes in vibrations of the housing corresponding to the number of taps.

7. The stand mixer of claim 6, wherein the accelerometer is configured to determine changes in vibrations of the housing by comparing a measured vibration at the housing to a threshold vibration value, wherein determining the changes in vibration comprises determining the measured vibration at the housing surpasses the threshold vibration value.

8. A method for operating a stand mixer, the stand mixer comprising a housing, a motor disposed in the housing, a mixing shaft operably coupled to the motor, a controller, and an accelerometer in data communication with the controller, the method comprising:
receiving, by the controller, tap data from the accelerometer;
determining, by the controller, a command based upon the tap data from the accelerometer; and
operating, by the controller, the stand mixer in response to the determined command.

9. The method of claim 8, further comprising determining a total number of taps from the tap data from the accelerometer.

10. The method of claim 9, wherein determining the command is based upon the total number of taps determined from the tap data from the accelerometer, the total number of taps corresponds to a respective command.

11. The method of claim 10, wherein operating the stand mixer in response to the determined command comprises one of starting a timer, pausing the timer, initiating a scale, zeroing the scale, pausing the motor, reducing a speed of the motor, and reversing a direction of the motor.

12. The method of claim 11, further comprising receiving command data from an external device, the command data indicative of which of the respective commands corresponds to a respective total number of taps.

13. The method of claim 9, further comprising determining, by the accelerometer, a number of changes in vibrations of the housing corresponding to the number of taps.

14. The method of claim 13, wherein the accelerometer is configured to determine changes in vibrations of the housing by comparing a measured vibration at the housing to a threshold vibration value, wherein determining the changes in vibration comprises determining the measured vibration at the housing surpasses the threshold vibration value.

15. A method for operating a stand mixer, the stand mixer comprising a housing, a motor disposed in the housing, a controller, and a sensor in data communication with the controller, the method comprising:
receiving, by the controller, tap data from the sensor;
determining, by the controller, a command based upon the tap data from the sensor; and
operating, by the controller, the stand mixer in response to the determined command.

16. The method of claim 15, wherein the sensor detecting the tapping of the housing of the stand mixer is one of an accelerometer and a capacitive touch sensor.

17. The method of claim 16, wherein the sensor is the accelerometer, the method further comprising determining, by the accelerometer, a number of changes in vibrations of the housing corresponding to a number of taps at the housing.

18. The method of claim 16, wherein the sensor is the capacitive touch sensor, the method further comprising detecting, by the capacitive touch sensor, changes in capacitance at the housing, a number of changes in capacitance at the housing corresponding to a number of taps at the housing.

19. The method of claim 15, further comprising determining a total number of taps from the tap data from the sensor, wherein determining the command is based upon the total number of taps determined from the tap data from the sensor, the total number of taps corresponds to a respective command.

20. The method of claim 19, wherein operating the stand mixer in response to the determined command comprises one of starting a timer, pausing the timer, initiating a scale, zeroing the scale, pausing the motor, reducing a speed of the motor, and reversing a direction of the motor.
